(19) United States
(12) Patent Application Publication
(10) Pub. No.: US 2011/0102823 A1
(43) Pub. Date: May 5, 2011

(54) IMAGE PROCESSING APPARATUS, IMAGE PROCESSING METHOD, AND COMPUTER-READABLE RECORDING MEDIUM

(76) Inventor: Kenji ONOGI, Osaka (JP)

(21) Appl. No.: 12/917,146

(22) Filed: Nov. 1, 2010

(30) Foreign Application Priority Data
Nov. 2, 2009 (JP) 2009-252430

(51) Int. Cl. H04N 1/60; G06K 9/00

(52) U.S. Cl. 358/1.9; 382/163

(57) ABSTRACT

An image processing apparatus carries out a combining process in which a part of an original image is whitened and a target image to be combined is superimposed over the whitened part. The image processing apparatus receives a command to specify a color of an unnecessary region of the stamp image including the target image to be combined which region is not to be superimposed over the original image in the combining process. Then, the image processing apparatus receives a command to define a necessary region of a specified color region of the stamp image which necessary region should not be defined as the unnecessary region, the specified color region being constituted by pixels indicating the color specified by the command. Further, the image processing apparatus carries out the combining process, assuming that the unnecessary region is a region of the stamp image which region is obtained by excluding the necessary region from the specified color region and the target image to be combined is a region other than the unnecessary region in the stamp image.

This Nonprovisional application claims priority under 35 U.S.C. §119(a) on Patent Application No. 2009-252430 filed in Japan on Nov. 2, 2009, the entire contents of which are hereby incorporated by reference.

### TECHNICAL FIELD

The present invention relates to an image processing apparatus and an image processing program in each of which a stamp image is combined with an original image, and to a recording medium in which the image processing program is recorded.

### BACKGROUND ART

Some image forming apparatuses such as a copying machine and a multifunction printer have a function in which an original image read from a document can be printed out as a combined image obtained by combining a mark such as a text and/or a sign with the original image. Further, in order to avoid occurrence of a color mixture due to combination, Patent Literatures 1 and 2 disclose techniques in each of which, in order to combine a text image (stamp image) with an original image, a whitening process is carried out with respect to the original image and the text image is combined with a part of the original image which part has been subjected to the whitening process.

### CITATION LIST

### Patent Literature 1

Japanese Patent Application Publication, Tokukaihei, No. 5-16392 A (Publication Date: Jan. 26, 1993)

### Patent Literature 2

Japanese Patent Application Publication, Tokukai, No. 2007-318468 A (Publication Date: Dec. 6, 2007)

### SUMMARY OF INVENTION

### Technical Problem

According to combining processes of Patent Literatures 1 and 2, an image including a colored text (including a given pattern such as a number and/or a symbol) which is preliminarily registered serves as a stamp image, a shape of the colored part of the stamp image is regarded as a whitened shape, and a whitening process is carried out so that the whitened shape occurs on an original image.

In contrast, for example, in a case where a pattern 100 shown in a stamp image of FIG. 1 is combined with an original image by use of what is processed in Patent Literatures 1 and 2, the following problem occurs. According to what is processed in Patent Literatures 1 and 2, a colored part of a stamp image is a whitened part and a white part of the stamp image is an unnecessary region (a region which is unnecessary for combination). Therefore, a whitening process is carried out with respect to a part of the original image which part corresponds to a colored part 100a of the pattern 100, whereas no whitening process is carried out with respect to a part of the original image which part corresponds to a white part 100b of the pattern 100. This causes a problem that: the colored part 100a of the pattern 100 shown in the stamp image is combined with the original image, whereas the white part 100b of the pattern 100 shown in the stamp image is not combined with the original image. Namely, over a combined image, the colored part 100a of the pattern 100 of FIG. 1 is superimposed, whereas the white part 100b of the pattern 100 of FIG. 1 is not superimposed. A color of a part of the original image which part corresponds to the white part 100b remains as it is without being whitened. Accordingly, what is processed in Patent Literatures 1 and 2 causes a problem that, in a case where a pattern of a target to be combined has a white part, it is impossible to faithfully reflect the pattern on an original image.

The present invention has been made in view of the problems. An object of the present invention is to provide an image processing apparatus in which a combining process to combine, with an original image, a part to be combined which is shown in a stamp image can be carried out to faithfully reflect, on the original image, the part to be combined.

### Solution to Problem

In order to attain the object, an image processing apparatus of the present invention for carrying out a combining process in which a target image to be combined is superimposed over a part of an original image, the image processing apparatus includes: an input section for receiving a stamp image including the target image to be combined; a color specifying section for receiving a command to specify a color of an unnecessary region of the stamp image which region is not to be superimposed over the original image in the combining process; a necessary region defining section for causing a display section to display a discriminating image in which a specified color region of the stamp image which region is constituted by pixels indicating the color specified by the command is discriminable, and receiving a command to define a necessary region of the specified color region which necessary region should not be defined as the unnecessary region; and a combining processing section for whitening the part of the original image, over which part the target image to be combined is to be superimposed, and superimposing, over the part of the original image which part has been whitened, the target image to be combined, assuming that the unnecessary region is a region of the stamp image which region is obtained by excluding the necessary region from the specified color region and the target image to be combined is a region other than the unnecessary region in the stamp image.

According to the arrangement, a user specifies the color of the unnecessary region of the stamp image and the region of the stamp image which region indicates the color of the unnecessary region is the specified color region. Further, the user also defines the necessary region of the specified color region which region should not be the unnecessary region. Assuming that the unnecessary region is the region which is obtained by excluding the necessary region from the specified color region and the target image to be combined is the region other than the unnecessary region in the stamp image, the part of the original image, over which part the target image to be combined is to be superimposed, is whitened, and the target image to be combined is superimposed over the original image. Therefore, even if a part of the stamp image which part should be combined includes a part indicating a color identical to that of the unnecessary region, it is also possible to securely superimpose, over the original image, the part indicating the color identical to that of the unnecessary region by defining, as the necessary region, the part indicating the color identical to that of the unnecessary region. As a result, the combining process can faithfully reflect, on the original image, a pattern of a part to be combined which is shown in the stamp image.

### ADVANTAGEOUS EFFECTS OF INVENTION

According to the arrangement of the present invention, a combining process to superimpose, over a part of an original image, a target image to be combined which is shown in a stamp image can be carried out to faithfully reflect, on the original image, a pattern of the target image to be combined.

### BRIEF DESCRIPTION OF DRAWINGS

FIG. 1

FIG. 1 illustrates an example of a stamp image.

FIG. 2

FIG. 2 is a block diagram illustrating pieces of hardware which are included in a multifunction printer of the present embodiment.

FIG. 3

FIG. 3 illustrates what is processed in a combining process of the present embodiment.

FIG. 4

FIG. 4 illustrates a selection screen which is used for specifying a color of an unnecessary region.

FIG. 5

FIG. 5 illustrates an RGB value input screen which is used for specifying a color of an unnecessary region.

FIG. 6

FIG. 6 illustrates a screen on which a preview image of a stamp image is displayed.

FIG. 7

FIG. 7 illustrates a binary image indicating a specified color region and label data corresponding to the binary image.

FIG. 8

FIG. 8 illustrates a display screen on which a binary image indicating a specified color region is displayed.

FIG. 9

FIG. 9 illustrates a display screen on which a binary image in which a necessary region has been excluded from a specified color region is displayed.

FIG. 10

FIG. 10 illustrates a display screen for urging a user to add an unnecessary region.

FIG. 11

FIG. 11 has enlarged views of (i) a stamp image in which a color mixture occurs along a boundary (a contour part) between an unnecessary region and a target image to be combined and (ii) a combined image which has been subjected to a combining process carried out by use of the stamp image.

FIG. 12

FIG. 12 illustrates a dilation process carried out with respect to an unnecessary region of a binary image.

FIG. 13

FIG. 13 illustrates a combined image obtained from a combining process of a third embodiment.

FIG. 14

FIG. 14 illustrates a standby image which a display section is caused to display in a second embodiment.

FIG. 15

FIG. 15 illustrates a standby image which a display section is caused to display in the third embodiment.

### DESCRIPTION OF EMBODIMENTS

### First Embodiment

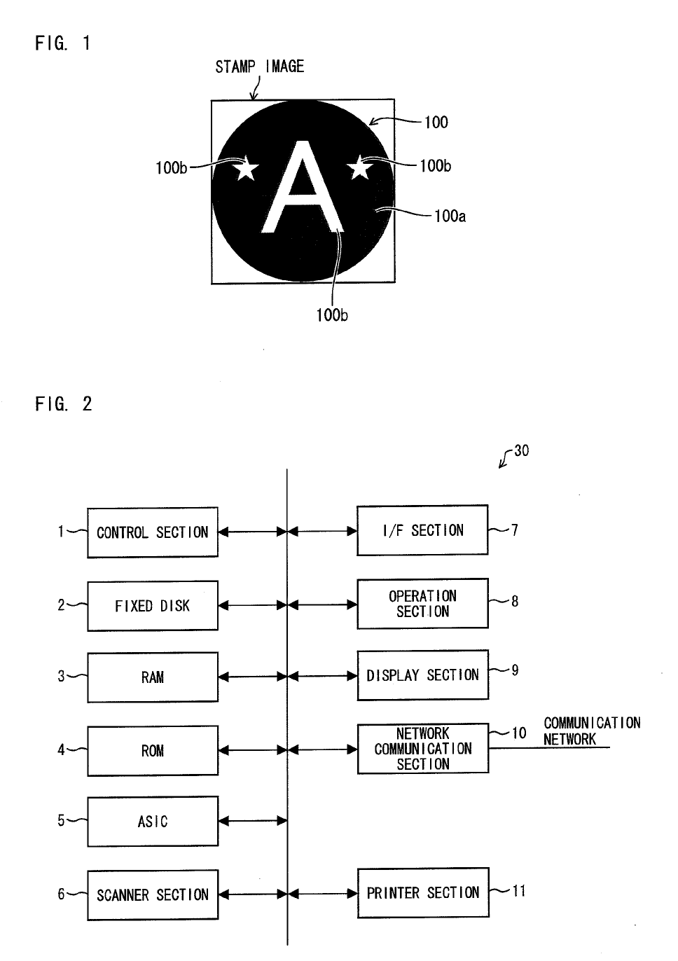

An embodiment of the present invention is specifically described below. FIG. 2 is a block diagram illustrating pieces of hardware which are included in a digital multifunction printer (herein after simply referred to as “a multifunction printer”) of the present embodiment.

A multifunction printer (an image processing apparatus) 30 of the present embodiment includes a control section 1, a fixed disk 2, a RAM 3, a ROM 4, an ASIC 5, a scanner section 6, an I/F section 7, an operation section 8, a display section 9, a network communication section 10, and a printer section 11 (see FIG. 2).

The control section 1 has a function of generally controlling the pieces of hardware which are included in the multifunction printer 30. Further, the control section 1, which is a processor (e.g. a computer such as a CPU), also has a function of carrying out image processing with respect to image data. The control section 1 executes a program, thereby realizing the control of the pieces of hardware which are included in the multifunction printer 30, the image processing, and various processes. Note that the program is stored in a computer-readable recording medium such as the ROM 4 and the control section 1 reads out the program stored in the ROM 4, so as to execute the program. Note also that the program can be stored in a removable recording medium and the control section 1 reads out a control program from the removable recording medium, so as to execute the control program.

The fixed disk 2, which is an auxiliary storage device, is constituted by, for example, a hard disk. The fixed disk 2 functions as a storage region in which image data and various data are stored/saved. The RAM (Random Access Memory) 3, which is a main storage device, serves as a storage region in which a program and image data which is being processed are stored. The ROM (Read Only Memory) 4, which is a nonvolatile memory, serves as a region in which the program carried out by the control section 1 is stored.

The ASIC (application specific integrated circuit) 5 is an integrated circuit which (i) receives image data (an image signal) written on the RAM 3, (ii) carries out image processing with respect to the received image data, and (iii) outputs the image data which has been subjected to image processing. The ASIC carries out the image processing at a higher speed than the control section 1. Further, the ASIC 5 carries out, with respect to the image data, a color correction from data of an additive color mixture showing RGB to data of a subtractive color mixture showing CMYK. Note that R, G, B, C, M, Y, and K denote red, green, blue, cyan, magenta, yellow, and black, respectively.

The scanner section 6 scans image data from a color document, so as to send the image data to the RAM 3. Note that the image data scanned by the scanner section 6 is RGB image data.

The I/F section 7 is an interface which receives data from an external medium (a removable storage device) such as a USB device, so as to send the data to the RAM 3. Further, the I/F section 7 can also receive RGB image data, so as to write the RGB image data onto the RAM 3.

The display section 9, which is a display device for displaying various pieces of information to a user, is constituted by a liquid crystal display device or an organic EL display device. Note that the display section 9 of the present embodiment is covered with a touch panel. The operation section 8, which is constituted by the touch panel and a keyboard (not illustrated), functions as an interface to which the user supplies various commands to cause the multifunction printer 30 to operate.

The network communication section 10, which is a block functioning as an interface with a communication network such as a LAN, sends/receives control information and image data to/from an apparatus other than the multifunction printer 30. Further, the network communication section 10 can also receive RGB image data from a terminal device which is connected to the communication network, so as to write the RGB image data onto the RAM 3.

The printer section 11 is a printing apparatus (print engine) employing an electrophotographic printing method. Specifically, the printer section 11 receives CMYK image data from the RAM 3, so as to print a full-color image on paper by use of CMYK toners in accordance with the CMYK image data.

The multifunction printer 30 as described above is arranged such that the color correction is carried out with respect to the RGB image data inputted via the scanner section 6 so that the RGB image data is converted to the CMYK image data and an image is printed on paper in accordance with the CMYK image data. Further, the multifunction printer 30 is arranged such that an image is printed on paper in accordance with image data received from an external device via the network communication section 10 (Note that, also in this case, the color correction is carried out according to need).

In addition, the multifunction printer 30 also has a function in which, when a stamp image is preliminarily saved in the fixed disk 2, a combining process is carried out, in response to instructions from the user, in which a target image to be combined that is shown in the stamp image is superimposed over a part of an original image, thereby printing, on paper, a combined image (the original image over which the target image to be combined has been superimposed) obtained from the combining process.

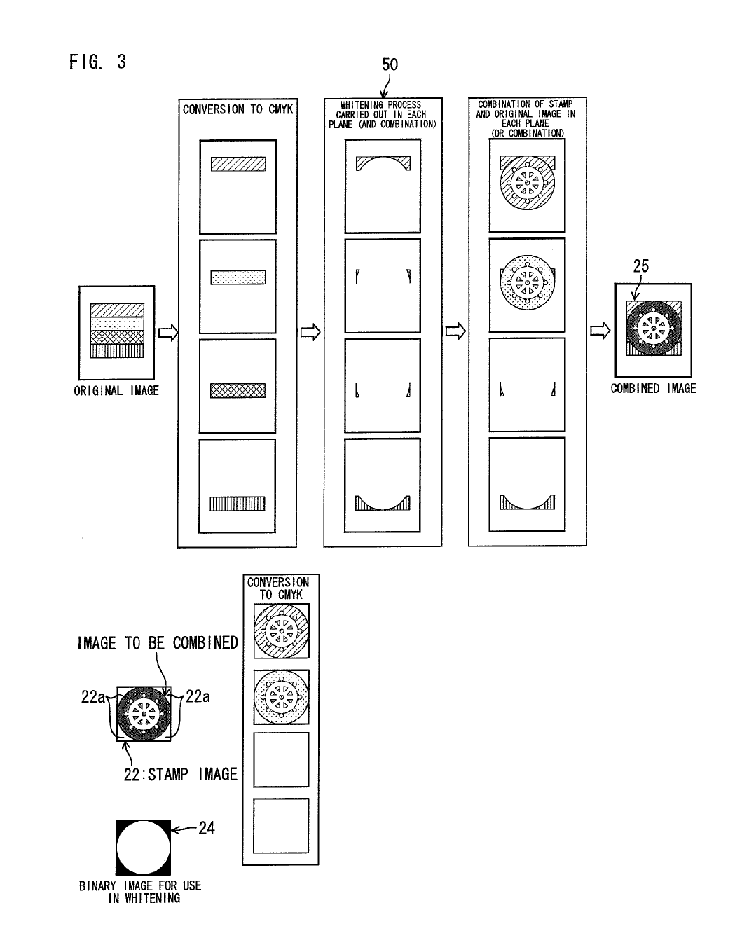

A stamp image and a combining process of the present embodiment are schematically described below. Note that, in the following combining process, a target image to be combined which is shown in a stamp image 22 (see FIG. 3) is superimposed over a part of an original image (see FIG. 3).

First of all, an original image of the present embodiment refers to an image which is to be copied in a copy mode or an image which is received from a terminal device so as to be printed in a print mode. Namely, an original image refers to an image shown in image data which is scanned by the scanner section 6 and used in a printing process or an image shown in image data which is inputted via the network communication section 10 and used in a printing process. Note that image data of an original image is sent to and stored in the RAM 3 as RGB data.

A stamp image of the present embodiment refers to an image which is prepared so as to be combined with an original image and is imported from outside into the multifunction printer 30. Note that the stamp image 22 of the present embodiment is constituted by (i) a target image to be combined which is a part to be superimposed over an original image and (ii) an unnecessary region 22a which is not superimposed over the original image. The unnecessary region, which corresponds to a background region as opposed to the target image to be combined, is a solid image region over which a given color is painted. Note that the given color, which is white in the present embodiment, is not limited to white.

Note that a stamp image can be prepared in a terminal device (personal computer) having an application for preparing a stamp image and imported from the terminal device into the multifunction printer 30 via the network communication section 10. A stamp image can also be downloaded from a given website via, for example, the Internet. Alternatively, a stamp image can be imported from the I/F section 7 via a removable storage medium.

The stamp image, which has been imported into the multifunction printer 30, is temporarily written onto the RAM 3. The multifunction printer 30 carries out processes (1) through (5) (described later) in accordance with the stamp image written on the RAM 3. Thereafter, the stamp image is saved in the fixed disk 2. Note that a description of a specific method for the import, a compression format of the stamp image, and the like, which are publicly known, is omitted. Further, image data of the stamp image is imported into the multifunction printer 30 as RGB data.

In each of the image data of (i) the original image and (ii) the stamp image which data are stored in the RAM 3, one pixel data is constituted by 8-bit R data, 8-bit G data, and 8-bit B data (i.e., data for one pixel is constituted by 24-bit RGB data). The image data is a string constituted by arranging pieces of one pixel data from the leftmost pixel to the right most pixel in each line from the uppermost line, through subsequent lines, to the lowermost line. Note that, though a description of an image header region and the like is omitted for simplicity, the image data contains information including the number of pixels arranged in vertical and transverse directions which is necessary for carrying out image processing.

A target image to be combined which is shown in a stamp image (data of a target image to be combined) is combined with an original image (data of an original image). A combined image (data of a combined image) obtained from the combination is sent to the printer section 11. The printer section 11 outputs (prints) the combined image on paper in accordance with the combined image data (see FIG. 3).

The following description specifically discusses a flow of a series of processes carried out from when the stamp image is imported to when the combined image is printed. Note that the series of processes consists of (1) through (5).

(1) Color Specification

When image data of a stamp image (hereinafter referred to as stamp image data) is imported into the multifunction printer 30 so as to be written onto the RAM 3, the control section 1 carries out a process in which a user specifies a color of an unnecessary region (a region which is not superimposed over an original image and is the background region) of the stamp image.

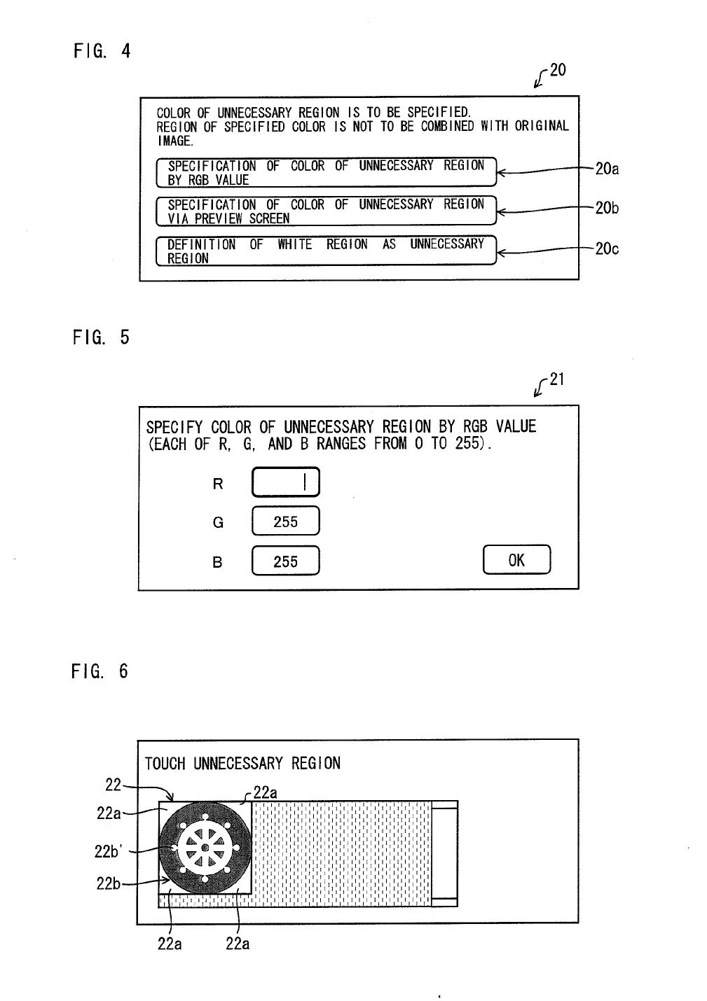

A method for specifying a color of an unnecessary region is specifically described below. When the stamp image is imported into the multifunction printer 30 so as to be written onto the RAM 3, the control section 1 causes the display section 9 to display a standby screen waiting for a command to carry out color specification (to specify a color of an unnecessary region of the stamp image). Note that a preview image of the imported stamp image is also displayed on the standby screen. Accordingly, the user can check the imported stamp image and a color of the unnecessary region by observing the standby screen. When the user inputs, via the operation section 8, the command to carry out color specification, the control section 1 causes the display section 9 to display a selection screen 20 (see FIG. 4).

As illustrated in FIG. 4, an RGB value input button 20a, a preview button 20b, a white specification button 20c are displayed on the selection screen 20. The user specifies the color of the unnecessary region by selecting any one of the RGB value input button 20a, the preview button 20b, and the white specification button 20c.

The RGB value input button 20a is a button for carrying out a process for causing the user to input an RGB value of the color of the unnecessary region. Namely, the user inputs an RGB value, thereby specifying that a color indicated by the RGB value is the color of the unnecessary region. Specifically, when the user touches the RGB value input button 20a, the control section 1 causes the display section 9 to display an RGB value input screen 21 (see FIG. 5). Then, the user supplies the RGB value to the multifunction printer 30 via the RGB value input screen 21. The control section 1 writes the supplied RGB value onto the RAM 3 as color information indicating the color of the unnecessary region. Note that an R value, a G value, and a B value are a red pixel concentration value, a green pixel concentration value, and a blue pixel concentration value, respectively. Note also that, in the present embodiment, the RGB values, each of which is 8-bit data, are indicated by 0 (black) to 255 (white).

The preview button 20b is a button for carrying out a process for causing the display section 9 to display the preview image of the stamp image and allowing the user to touch a pixel of the unnecessary region. Specifically, the user defines, of the displayed preview image of stamp image, a part which should be the unnecessary region, thereby specifying that a color of the pixel of the part is a color of the unnecessary region. The process carried out by the preview button 20b is specifically described below. When the user touches the preview button 20b of FIG. 4, the control section 1 causes the display section 9 to display a preview image of the stamp image 22 written on the RAM 3 (see FIG. 6). Then, when the user touches the displayed preview image of the stamp image 22, an address on the RAM 3 is found based on coordinates of a touched part, so as to specify a pixel corresponding to the touched part. Thereafter, the control section 1 finds an RGB value of the specified pixel, so as to write the RGB value onto the RAM 3 as the color information indicating the color of the unnecessary region. Note that the control section 1 can carry out an enlargement process or a reduction process with respect to the stamp image in accordance with a command inputted by the user and cause the display section 9 to display, as a preview image, the stamp image which has been subjected to the enlargement process or the reduction process.

The white specification button 20c is a button for specifying that a white region of the stamp image is the unnecessary region. Namely, the user touches the white specification button 20c, thereby specifying that white is a color of the unnecessary region. Specifically, when the user touches the white specification button 20c, the control section 1 writes R=255, G=255, and B=255 onto the RAM 3 as the color information indicating the color of the unnecessary region. The reason why the white specification button 20c is provided is that the unnecessary region of the stamp image is the background region which is often shown in white.

As described earlier, there are various methods in which the user specifies the color of the unnecessary region. When the user specifies the color of the unnecessary region, the control section 1 receives the color information (RGB value) indicating the color specified by the user (hereinafter referred to as “a specified color”), so as to write the color information onto the RAM 3. Note that a total bit count of the RGB value per pixel is 24. The color information is written onto the RAM 3 in 24 bits and in hexadecimal numbers. For example, the color information indicating white is “FF FF FF”.

(2) Binary Image Generation

When a specified color (a color identical to that of the unnecessary region) is specified as above, the control section 1 carries out a process in which a binary image is generated for causing the user to discriminate a region constituted by pixels indicating the specified color (hereinafter referred to as “a specified color region”) and the binary image is displayed in the display section 9. The process in which the binary image is generated is described below.

First of all, the control section 1 secures, in the RAM 3, a storage region equivalent to a size one-twenty-fourth of that of the stamp image, so as to carry out an initialization process (clearance to 0 (zero)) with respect to the storage region. This means that a storage region has been secured in the RAM 3 for writing a binary image whose number of pixels is identical to that of pixels of the stamp image (the bit count for one pixel of the stamp image is 24, whereas the bit count for one pixel of the binary image is 1).

Next, the control section 1 compares, with the color information (24 bits), RGB values of respective pixels of the stamp image which values are written on the RAM 3, by reference to each pixel (24 bits) in order from a start address. Then, as for a pixel indicating a color identical to the color information (a pixel whose value perfectly matches the color information), “1” (a valid value) is substituted for a value of a corresponding pixel of the binary image. As for a pixel indicating a color different from the color information, substitution of a value of a corresponding pixel of the binary image is not carried out. For example, in a case where the specified color is R=255, G=255, and B=255, “1” is substituted for only a value of a pixel of the binary image which pixel corresponds to a pixel of the stamp image which pixel indicates R=255, G=255, and B=255. This makes it possible to prepare a binary image in which a value of a pixel indicating the specified color is “1” and a value of a pixel indicating a color different from the specified color is “0”. Namely, the binary image is an image in which a specified color region is discriminable.

For example, in a case where 8 pixels are arranged in the binary image prepared as above such that pixels indicating the specified color and pixels indicating no specified color are alternately aligned, the case is expressed as “10101010” in 8 bits and in binary notation and as “AA” in 1 byte and in hexadecimal notation.

Further, the control section 1 causes the display section 9 to display a binary image 23 in which a pixel of “1” is black and a pixel of “0” is white (see FIG. 8). Namely, the binary image displayed on the display section 9 is an image in which a specified color region is shown in black and a region other than the specified color region is shown in white.

Note here that, in the present embodiment, the unnecessary region (background region) 22a is located around a target image 22b to be combined and a color of the unnecessary region 22a is white (R=255, G=255, and B=255) in the stamp image 22 (see FIG. 6). A part corresponding to the unnecessary region 22a is the specified color region and black in the binary image 23 generated from the stamp image 22 (see FIG. 8). The stamp image 22 of the present embodiment has a part 22b′ which indicates a color (white) identical to that of the unnecessary region 22a in the target image 22b to be combined (see FIG. 6). For this reason, not only the part corresponding to the unnecessary region 22a but also a part corresponding to the part of the target image 22b to be combined which part is shown in white is treated as the specified color region and is therefore black (see FIG. 8). Namely, in a case where there is a part whose color is identical to that of the unnecessary region in a target region to be combined of the stamp image, not only the unnecessary region but also the part whose color is identical to that of the unnecessary region of the target region to be combined is shown in black and regarded as the specified color region in the generated binary image.

Note that, in a binary image generation process (already described), only a pixel which indicates a value identical to that inputted by the user is treated as a pixel indicating the specified color and “1” is substituted for the pixel indicating the specified color in the binary image. However, the binary image generation process is not limited to such an embodiment. For example, a pixel which falls within a given numerical range including the value inputted by the user can be treated as a pixel indicating the specified color. For example, in a case where the inputted value is (R=240, G=240, and B=240), a pixel of (R=235 to 245, G=235 to 245, and B=235 to 245) can be treated as the pixel indicating the specified color. Note also that it is possible to cause the ASIC 5 to carry out the binary image generation process (already described), which is carried out by the control section 1.

(3) Labeling

Next, the control section 1 carries out a labeling process with respect to the prepared binary image and a process in which label data indicating a result of the labeling process is recorded in the RAM 3. The labeling process is described below. First of all, the control section 1 secures, in the RAM 3, a region for storing the label data. A size of the region to be secured is adjusted in accordance with the number of kinds of labels. For example, assuming that a value of “0” refers to “unlabeled”, it is possible to use 255 kinds of labels in case of securing a region which is eight times larger than the binary image and to use 65535 kinds of labels in case of securing a region which is sixteen times larger than the binary image.

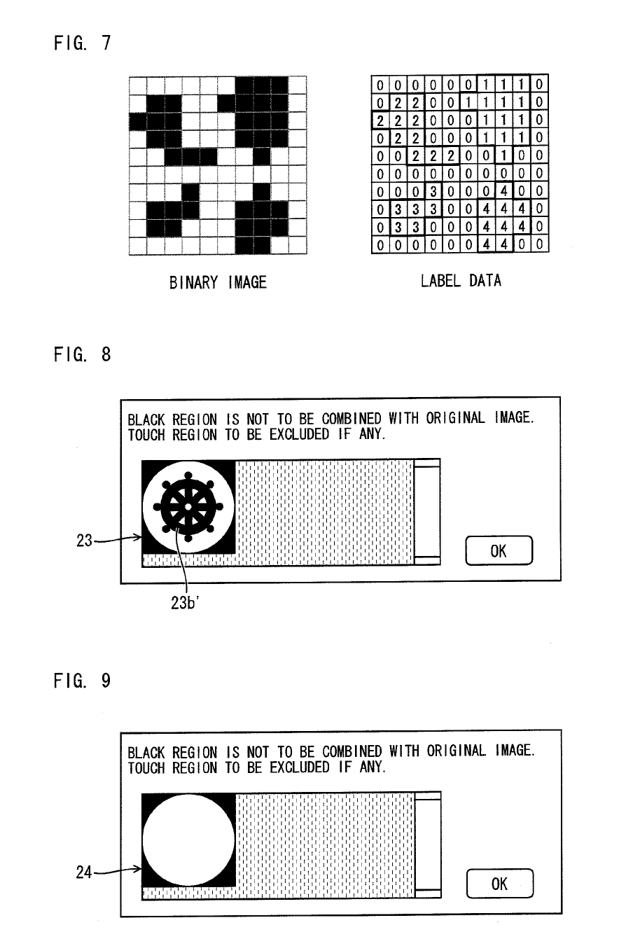

Subsequently, the control section 1 carries out the labeling process in which a region (specified color region) which is constituted by pixels indicating “1” is labeled in the binary image. Then, the control section 1 records, in the RAM 3, the label data indicating the result of the labeling process. Note that it is possible to carry out the labeling process by use of a well-known method. Note here that pixels corresponding to respective pixels of the binary image are shown in the label data (see FIG. 7). As for the specified color region, different label values are assigned to each connected region in which pixels are connected to each other.

Namely, of pixel groups indicating the specified color, identical labels are put on pixels of an identical connected region and different labels are put on pixels belonging to different connected regions. Note here that FIG. 7 illustrates a binary image and label data corresponding to the binary image. A pixel of a color other than the specified color is unlabeled and remains to be “0” in the label data of FIG. 7. In the label data of FIG. 7, of the pixel groups indicating the specified color, label data of “1” is put on an upper right connected region and label data of “2” is put on an upper left connected region. Note that the control section 1 causes the RAM 3 to record a maximum value N of used labels.

(4) Definition of Necessary Region

Next, the control section 1 carries out a process for causing the display section 9 to display the binary image and causing the user to define a necessary region of the specified color region. Of a region which is defined as the specified color region (i.e., a region whose color is identical to that of the unnecessary region), a region which should not be treated as the unnecessary region is referred to as the necessary region. Namely, the part 22b′ which indicates the color identical to that of the unnecessary region corresponds to the necessary region in the target image 22b to be combined which is shown in the stamp image 22 (see FIG. 6).

First of all, the control section 1 causes the display section 9 to display the binary image 23 and a message urging the user to touch the necessary region (see FIG. 8). Note that, in FIG. 8, “a region which should be excluded from a black region” refers to the necessary region.

In a case where a part touched by the user is a pixel of the specified color region (a pixel of “1” of the binary image), the control section 1 refers to the label data, so as to obtain a label of a pixel of the touched part. Then, the control section 1 recognizes, as the necessary region, all pixels on which labels identical to the obtained label are put, so as to substitute “0” for a value of “1” of a corresponding pixel of the binary image and substitute “0” for a value of a corresponding pixel of the label data (put no label on the corresponding pixel of the label data). This excludes the necessary region defined by the user from the specified color region shown in the binary image. Therefore, though the part 22b′ which is shown in white in the target image 22b to be combined of the stamp image 22 is the specified color region (black) in a corresponding part 23b′ of the binary image 23, it is possible to cause the corresponding part 23b′ to be a non-specified color region (white) (see a binary image 24 of FIG. 9) when touching the corresponding part 23b′. Namely, the corresponding part 23b′ of FIG. 8 is defined as the necessary region by the user and excluded from the specified color region (black).

Note that, in a case where a pixel touched by the user is not a pixel of the specified region (in case of the pixel of “0” of the binary image), the control section 1 does nothing or causes a caution message to be displayed. Then, until a “OK” button (illustrated in FIG. 8 or 9) is touched, the control section 1 continues to cause (i) a message urging the user to touch the necessary region and (ii) a screen showing the binary image (a screen of FIG. 8 or 9) to be displayed.

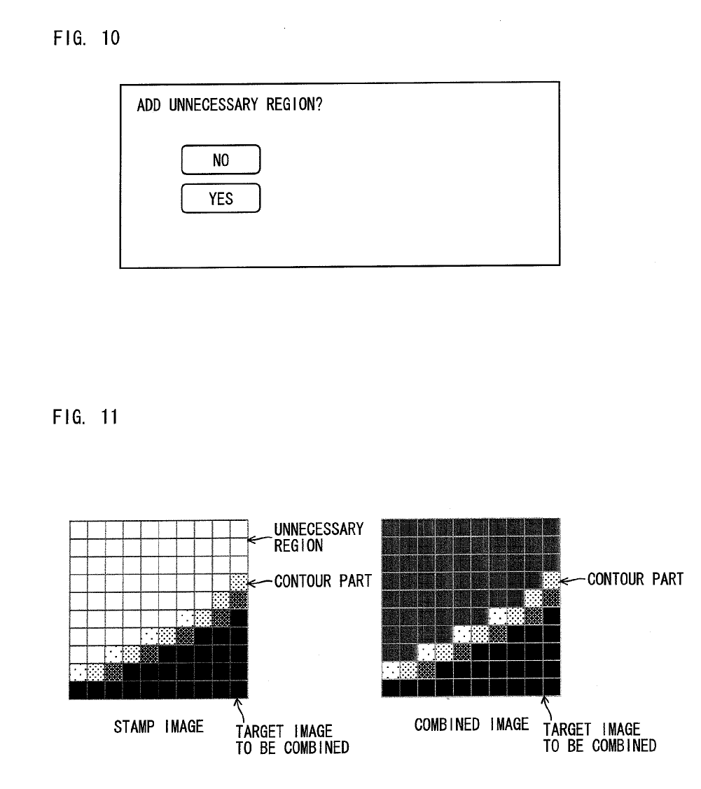

When the “OK” button is touched, the control section 1 causes the display section 9 to display a screen urging the unnecessary region to be added. FIG. 10 illustrates the screen.

When the user touches a “YES” button displayed on the screen (see FIG. 10), the control section 1 causes the selection screen 20 of FIG. 4 to be displayed again and allows the user to specify a color of the unnecessary region again (note that the color of the unnecessary region which color is specified here is referred to as a second specified color). When the user specifies the second specified color, the control section 1 writes, onto the RAM 3, second color information indicating the second specified color. Note here that, for a pixel indicating a value identical to that of the second color information, the control section 1 substitutes “1” for a value of a corresponding pixel of the binary image without rewriting the value of the pixel indicating “1” in the binary image which has been written on the RAM 3. Further, the control section 1 carries out the labeling process in which the pixel which has newly become “1” in the binary image is newly labeled. In the labeling process carried out here, labels are used in order from a label of N+1. Thereafter, the control section 1 causes the display section 9 to display a screen illustrated in FIG. 8 and urges the user to specify the necessary region. In a case where the user touches a part of the screen, the control section 1 obtains a label of a pixel of the touched part. Then, for all the pixels whose labels are identical to the obtained label, the control section 1 substitutes “0” for the value of “1” of corresponding pixels of the binary image and substitutes “0” for the value of corresponding pixels of the label data (puts no labels on the corresponding pixels of the label data). This can exclude, in the binary image, the necessary region from the specified color region constituted by pixels indicating the second specified color. According to the process described above, even if there are a plurality of unnecessary regions whose colors are different from each other, it is possible to set values of all the pixels of the plurality of unnecessary regions to “1” in a binary image.

When the user touches a “NO” button displayed on the screen (see FIG. 10), the control section 1 saves, in the fixed disk 2, the binary image generated as above and management information (information necessary for managing the binary image). Note that, in each of the following processes, the control section 1 treats, as the unnecessary region, the region of the binary image which region is constituted by the pixels of “1”. Namely, in a case where the user does not define the necessary region, all the region constituted by the pixels of the specified color is treated as the unnecessary region. In contrast, in a case where the user defines the necessary region, a region which is obtained by excluding the necessary region from the specified color region is treated as the unnecessary region.

(5) Whitening of Stamp Image

Next, the control region 1 refers to the binary image saved in the fixed disk 2, so as to carry out a whitening process with respect to the stamp image. Specifically, of the pixels of the stamp image, the control section 1 changes, into white, a color of a pixel corresponding to a pixel (the unnecessary region) indicating “1” in the binary image (namely, the control section 1 changes an RGB value of the pixel corresponding to the pixel indicating “1” in the binary image so that it is shown in white). Then, the control section 1 saves, in the fixed disk 2, not only the binary image and management information (information necessary for managing the binary image) but also the stamp image which has been subjected to the whitening process. This whitens all the pixels of the unnecessary region 22a other than the target image to be combined in the stamp image saved in the fixed disk 2 (see FIG. 3).

(6) Combining Process

When operation is started in the copy mode or the print mode, an original image which has not been printed is written onto the RAM 3. Note that, in the copy mode, the original image refers to an image inputted via the scanner section 6, whereas in the print mode, the original image refers to an image received from the terminal device via the network communication section 10.

Then, in a case where the user inputs a request for combination of a stamp and the original image in the copy mode or the print mode, the control section 1 reads out the stamp image and the binary image from the fixed disk 2, so as to write the stamp image and the binary image onto the RAM 3.

Next, the ASIC 5 carries out image processing necessary for printing with respect to the original image and the stamp image in order, and writes, onto the RAM 3, the original image and the stamp image which have been subjected to the image processing. In the image processing, each of data of the original image and data of the stamp image is converted from RGB data to CMYK data, so as to be subjected to a dithering process (see FIG. 3). Note that each of the CMYK data which have been subjected to the dithering process is 1-bit data (binary data) per pixel for each of planes of respective color components.

Subsequently, the ASIC 5 carries out the whitening process with respect to the original image for each of the planes. Specifically, the original image and the binary image which are written on the RAM 3 are supplied to the ASIC 5. Then, the ASIC 5 carries out an AND combination of the binary image 24 and the original image for each of the planes (see a reference sign 50 of FIG. 3). According to this, assuming that a region of the stamp image 22 other than the unnecessary region is the target image to be combined, a color of a part of the original image over which part the target image to be combined is superimposed is whitened (a concentration value of the part of the original image over which part the target image to be combined is to be superimposed later is converted to a value indicating white). Thereafter, the ASIC 5 outputs the original image which has been subjected to the whitening process, so as to write the original image onto the RAM 3.

Thereafter, the ASIC 5 superimposes the target image to be combined over the original image which has been subjected to the whitening process. Specifically, the original image which has been subjected to the whitening process and the stamp image which has been subjected to the whitening process are supplied to the ASIC 5. Then, the ASIC 5 carries out an OR combination of the stamp image which has been subjected to the whitening process and the original image which has been subjected to the whitening process (see FIG. 3). Namely, in each of the planes, the target image to be combined which is shown in the stamp image is superimposed for combination over a whitened part of the original image. This causes a combined image 25 in which the target image to be combined has been superimposed over the original image to be generated (see FIG. 3). Note that the ASIC 5 carries out the whitening process with respect to the original image and the combining process in which the target image to be combined is combined with the original image. Alternatively, the control section 1 can cause software to carry out the whitening process and the combining process. However, it is more preferable that the ASIC 5 carry out the whitening process and the combining process since the ASIC can realize higher-speed processing than the control section 1.

The control section 1 sends data of the combined image 25 generated as above to the printer section 11. The printer section 11 prints the combined image on paper in accordance with the received data.

As described earlier, the multifunction printer 30 of the present embodiment carries out a combining process in which a target image to be combined is superimposed over a part of an original image. In the multifunction printer 30, the I/F section 7 or the network communication section 10 functions as an input section for receiving a stamp image including the target image to be combined. The control section 1 functions as a color specifying section which receives, from a user, a command to specify a color of an unnecessary region. Further, the control section 1 causes the display section 9 to display a binary image (a discriminating image) in which a specified color region of the stamp image which region is constituted by pixels indicating the color specified by the user is discriminable. The control section 1 functions as a necessary region defining section which receives a command to define a necessary region of the specified color region. The control section 1 or the ASIC 5 functions as a combining processing section for whitening the part of the original image, over which part the target image to be combined is to be superimposed, and superimposing, over the part of the original image which part has been whitened, the target image to be combined, assuming that the unnecessary region is a region of the stamp image which region is obtained by excluding the necessary region from the specified color region and the target image to be combined is a region other than the unnecessary region in the stamp image.

According to the arrangement, the user specifies the color of the unnecessary region of the stamp image and the region of the stamp image which region indicates the color of the unnecessary region is the specified color region. Further, the user also defines the necessary region of the specified color region which region should not be the unnecessary region. Assuming that the unnecessary region is the region which is obtained by excluding the necessary region from the specified color region and the target image to be combined is the region other than the unnecessary region in the stamp image, the part of the original image, over which part the target image to be combined is to be superimposed, is whitened, and the target image to be combined is superimposed over the original image. Therefore, even if a part of the stamp image which part should be combined includes a part indicating a color identical to that of the unnecessary region, it is also possible to securely superimpose, over the original image, the part indicating the color identical to that of the unnecessary region by defining, as the necessary region, the part indicating the color identical to that of the unnecessary region. As a result, the combining process can faithfully reflect, on the original image, a pattern (color) of a part to be combined which is shown in the stamp image.

Note that the stamp image is imported from outside to the multifunction printer 30 according to the above embodiment. If an application for preparing a stamp image is installed in the multifunction printer 30, the stamp image can be prepared in the multifunction printer 30.

Assume that a single user prepares a stamp image in a terminal device or the like and uses the stamp image in the multifunction printer 30. When the unnecessary region is formed in a color other than the color used in the target region to be combined during preparation of the stamp image, it is unnecessary to carry out later the process described above in which the necessary region is defined.

Note that, in the present embodiment, the unnecessary region of the stamp image is preliminarily subjected to the whitening process. A reason for this is described below. In the present embodiment, the OR combination is used as a method in which the target image to be combined that is shown in the stamp image is superimposed for combination over the original image. In a case where a color of the unnecessary region of the stamp image is other than white, the color remains during the OR combination. Therefore, white (zero) is substituted for the color (a value) of the unnecessary region. Namely, in the present embodiment, white (zero) is substituted for the color (value) of the unnecessary region of the stamp image and, for a pixel of an original image which pixel corresponds to the unnecessary region, a value of the original image and zero are subjected to the OR combination so that the color of the unnecessary region is not reflected on a combined image. Note that, in the present embodiment, a method is employed in which the unnecessary region of the stamp image is whitened so as to be subjected to the OR combination as described above. It is also possible to employ a method in which a color of an unnecessary part of the stamp image is treated as a transparent color and a color of the original image is left as it is for the transparent color.

Note also that only images for use in the combination but no other images are supplied to the ASIC 5 during the AND combining process or the OR combining process. Therefore, the ASIC 5 does not combine the original image and the stamp image while referring to the binary image. Instead, the ASIC 5 first carries out the AND combination of the original image and the binary image and then carries out the OR combination of the original image and the stamp image, thereby superimposing, over the original image, only the target image part to be combined of the stamp image.

### Second Embodiment

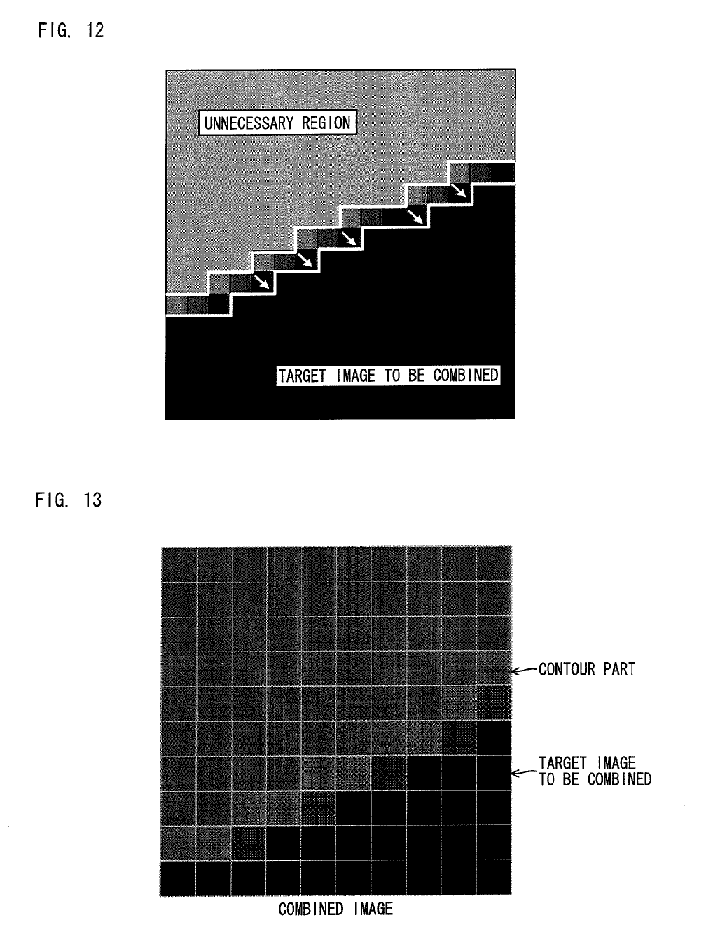

In a case where a stamp image which has been subjected to an anti-alias process is imported, a color mixture frequently occurs, in the stamp image, along a boundary part (contour part) between an unnecessary region and a target image to be combined (see FIG. 11). In a case where the combining process illustrated in FIG. 3 is carried out by use of the stamp image in which such a color mixture occurs, an unintended color consequently remains along the contour part of the target image to be combined in a combined image (see FIG. 11).

In view of the circumstances, in the present embodiment, a process (hereinafter referred to as a “contour removal process”) is carried out in which a contour part of a target image to be combined that is shown in a stamp image is removed. The process is specifically described below.

The present embodiment is similar to the First Embodiment in that “(1) Color Specification”, “(2) Binary Image Generation”, “(3) Labeling”, and “(4) Definition of Necessary Region” which have been already described are carried out after the stamp image is imported into a multifunction printer 30.

Then, the control section 1 carries out a first dilation process (note that this dilation process refers to an 8-neighborhood dilation process) with respect to an unnecessary region of a binary image after carrying out “(4) Definition of Necessary Region” and before carrying out “(5) Whitening of Stamp Image” (already described) (see FIG. 12). More specifically, the control section 1 first causes a display section 9 to display a standby image 300 illustrated in FIG. 14. The standby image 300 is a screen which urges a user to input the number of pixels which number indicates the number of dilations.

When the user inputs the number of pixels, the control section 1 repeatedly carries out the first dilation process with respect to the unnecessary region of the binary image as many times as the inputted number of pixels. Specifically, in a case where the inputted number of pixels is “1”, the control section 1 carries out the first dilation process only one time with respect to the unnecessary region of the binary image. In a case where the inputted number of pixels is “2”, the control section 1 carries out the first dilation process two times with respect to the unnecessary region of the binary image. In a case where the inputted number of pixels is “3”, the control section 1 carries out the first dilation process three times with respect to the unnecessary region of the binary image. (Namely, the number of pixels which number is inputted via the standby image 300 refers to the number of times of repeats of the first dilation process.) Then, the control section 1 saves, in the fixed disk 2, the binary image which has been subjected to the first dilation process and management information (information necessary for managing the binary image).

Thereafter, the control section (a removal processing section) 1 carries out “(5) Whitening of Stamp Image” by use of the binary image which has been subjected to the first dilation process. Namely, of pixels of the stamp image, the control section 1 changes, into white, a color of a pixel corresponding to the unnecessary region which has been subjected to the first dilation process. This removes the contour part of the target image to be combined which is shown in the stamp image (a boundary between the target image to be combined and the unnecessary region). Therefore, it is possible to eliminate a color mixture due to an influence of the anti-alias process. This allows prevention of an unintended color from remaining in the combined image.

Then, in a subsequent combining process, an OR combination is carried out by use of the binary image dilated as above and an original image, thereby carrying out whitening with respect to the original image. Therefore, a part of the original image which part has been whitened is identical in size to the target image to be combined which is shown in the stamp image that has been subjected to whitening (the target image to be combined from which the contour part has been removed). Thereafter, an AND combination is carried out by use of the original image which has been subjected to whitening and the stamp image which has been subjected to whitening, thereby generating a combined image.

### Third Embodiment

In a case where an unnecessary region of a stamp image is white, a color mixing part of a contour part of the stamp image illustrated in FIG. 11 becomes a whitish line. In such a case, when a combining process is carried out in which the contour part is covered with a color of an original image in a combined image, it is possible to prevent an unintended color from being noticeable in the combined image. A method for the combining process is described below.

The present embodiment is similar to the First Embodiment in that “(1) Color Specification”, “(2) Binary Image Generation”, “(3) Labeling”, and “(4) Definition of Necessary Region”, and “(5) Whitening of Stamp Image” which have been already described are carried out in this order after a stamp image is imported into a multifunction printer 30.

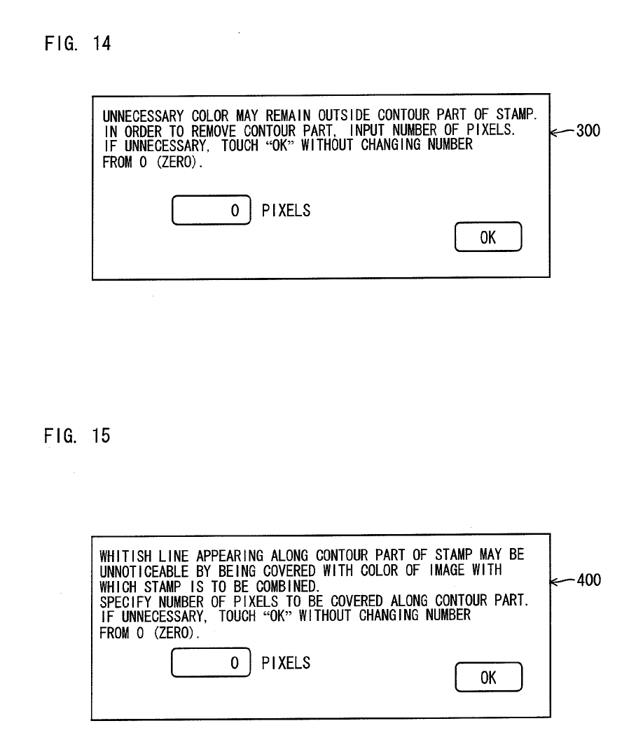

When operation is started in a copy mode or a print mode, an original image is written onto a RAM 3. In a case where a user inputs a request for combination of a stamp and the original image, a control section 1 reads out the stamp image and a binary image from a fixed disk 2, so as to write the stamp image and the binary image onto the RAM 3. Further, in the present embodiment, the control section 1 causes a display section 9 to display a standby image 400 illustrated in FIG. 15. The standby image 400 is a screen which urges a user to input the number of pixels which number indicates the number of dilations carried out in a second dilation process to be carried out later.

When the user inputs the number of pixels, the control section 1 repeatedly carries out a second dilation process (note that this dilation process refers to an 8-neighborhood dilation process) with respect to an unnecessary region of the binary image as many times as the inputted number of pixels. Then, the control section 1 writes, onto the RAM 3, the binary image which has been subjected to the second dilation process. Note that the second dilation process is carried out with respect to the binary image after whitening is carried out with respect to the stamp image. Therefore, a region of the binary image which region is other than the unnecessary region that has been subjected to the second dilation process (which region corresponds to a target image to be combined) is smaller than the target image to be combined which is shown in the stamp image.

Thereafter, an ASIC 5 carries out image processing necessary for printing with respect to the original image and the stamp image in order, and writes, onto the RAM 3, the original image and the stamp image which have been subjected to the image processing.

Further, the ASIC 5 carries out the whitening process with respect to the original image for each of planes. Specifically, the original image and the binary image (the binary image which has been subjected to the second dilation process) which are written on the RAM 3 are supplied to the ASIC 5. Then, the ASIC 5 carries out an AND combination of a binary image 24 and the original image for each of the planes, so as to write, onto the RAM 3, the original image which has been subjected to the AND combination (the whitening process). Note here that a whitened part generated in the original image is smaller than the target image to be combined which is shown in the stamp image which has been subjected to the whitening process.

Next, the ASIC 5 superimposes the target image to be combined over the original image which has been subjected to the whitening process. Specifically, the original image which has been subjected to the whitening process and the stamp image which has been subjected to the whitening process are supplied to the ASIC 5. Then, the ASIC 5 carries out an OR combination of the stamp image which has been subjected to the whitening process and the original image which has been subjected to the whitening process for each of the planes, so as to output a combined image.

According to a procedure as described above in which the processes are carried out, whitening of the stamp image is carried out in accordance with the binary image which has not been subjected to the second dilation process and whitening of the original image is carried out in accordance with the binary image which has been subjected to the second dilation process, so that the stamp image which has been subjected to whitening is combined with the original image which has been subjected to whitening. Therefore, a contour part of the target image to be combined of the stamp image is covered with a color of the original image in the combined image. Accordingly, according to the processes of the present embodiment, even in a case where the contour part shown in the stamp image becomes a whitish line due to a color mixture occurring between the contour part and the unnecessary region, it is possible to prevent the whitish line from being noticeable by causing the contour part to be covered with the color of the original image in the combined image (see FIG. 13). In contrast, in a case where no second dilation process is carried out, there may occur inconvenience such that the whitish line remains as it is in the combined image (see FIG. 11).

Note that the processes of the present embodiment are carried out as a measure to prevent the contour part from being noticeable by intentionally covering the contour part with the original image. Such a measure is especially effective in a case where the contour part is whitish. In contrast, according to the processes of the Second Embodiment, the contour itself of the target image to be combined which is shown in the stamp image is removed. Therefore, the processes of the Second Embodiment are effective as long as a color mixture occurs in the contour part irrespective of a color of the contour region.

Note also that it is possible to carry out the second dilation process of the Third Embodiment after carrying out the first dilation process of the Second Embodiment. A flow of this process is described below. After “(4) Definition of Necessary Region” described in the First Embodiment is ended, the first dilation process is carried out with respect to the unnecessary region of the binary image and then the whitening process is carried out with respect to the stamp image in accordance with the binary image which has been subjected to the first dilation process. This removes the contour region of the target image to be combined which is shown in the stamp image. Thereafter, the second dilation process is carried out with respect to the unnecessary region of the binary image which has been subjected to the first dilation process. Subsequently, the whitening process is carried out with respect to the original image by use of the binary image which has been subjected to the second dilation process. Then, the target image to be combined of the stamp image which has been subjected to the whitening process is superimposed over the original image which has been subjected to the whitening process, thereby generating the combined image. As a result of this, (i) the target image to be combined of the stamp image from which target image the contour part is removed can be combined with the original image and (ii) an edge part of the target image to be combined from which the contour part has been removed can be covered with the color of the original image.

Note that each of the dilation processes carried out in the Second and Third Embodiments is an 8-neighborhood dilation. A dilation process can be a 4-neighborhood dilation or a combination of a 4-neighborhood dilation and an 8-neighborhood dilation. Note also that, though the number of repeats of the dilation process is specified by the user in each of the Second and Third Embodiments, the dilation process can be repeatedly carried out as many as the predetermined number (e.g., two times or three times) which is not specified by the user.

The present invention is not limited to the description of the embodiments above, but may be altered by a skilled person within the scope of the claims. An embodiment based on a proper combination of technical means disclosed in different embodiments is encompassed in the technical scope of the present invention.

### Summary of Embodiments

An image processing apparatus of the present invention for carrying out a combining process in which a target image to be combined is superimposed over a part of an original image, the image processing apparatus includes: an input section for receiving a stamp image including the target image to be combined; a color specifying section for receiving a command to specify a color of an unnecessary region of the stamp image which region is not to be superimposed over the original image in the combining process; a necessary region defining section for causing a display section to display a discriminating image in which a specified color region of the stamp image which region is constituted by pixels indicating the color specified by the command is discriminable, and receiving a command to define a necessary region of the specified color region which necessary region should not be defined as the unnecessary region; and a combining processing section for whitening the part of the original image, over which part the target image to be combined is to be superimposed, and superimposing, over the part of the original image which part has been whitened, the target image to be combined, assuming that the unnecessary region is a region of the stamp image which region is obtained by excluding the necessary region from the specified color region and the target image to be combined is a region other than the unnecessary region in the stamp image.

According to the arrangement, a user specifies the color of the unnecessary region of the stamp image and the region of the stamp image which region indicates the color of the unnecessary region is the specified color region. Further, the user also defines the necessary region of the specified color region which region should not be the unnecessary region. Assuming that the unnecessary region is the region which is obtained by excluding the necessary region from the specified color region and the target image to be combined is the region other than the unnecessary region in the stamp image, the part of the original image, over which part the target image to be combined is to be superimposed, is whitened, and the target image to be combined is superimposed over the original image. Therefore, even if a part of the stamp image which part should be combined includes a part indicating a color identical to that of the unnecessary region, it is also possible to securely superimpose, over the original image, the part indicating the color identical to that of the unnecessary region by defining, as the necessary region, the part indicating the color identical to that of the unnecessary region. As a result, the combining process can faithfully reflect, on the original image, a pattern of a part to be combined which is shown in the stamp image.

The image processing apparatus of each of the embodiments of the present invention can be arranged such that: assuming that, in the specified color region, a region which is constituted by connected pixel groups is a connected region, the necessary region defining section carries out, with respect to the specified color region, a labeling process in which identical labels are put on pixels of an identical connected region and different labels are put on pixels which belong to different connected regions; and the necessary region defining section allows a user to define a part of the discriminating image, and recognizes, as the necessary region, a region of the stamp image which region is constituted by pixels sharing an identical label with the part defined by the user. According to the arrangement, since it is possible to define the necessary region only by defining a part of the necessary region shown in the discriminating image, the user has an advantage of easily defining the necessary region.

The image processing apparatus of each of the embodiments of the present invention can further include: a removal processing section for removing, from the stamp image, a contour part of the target image to be combined, the combining processing section superimposing, over the original image, the target image which has been subjected to the removal. According to this, even if a color mixture due to an influence of an anti-alias process occurs in the target image to be combined which is shown in the stamp image, it is possible to reduce an influence of the color mixture in a combined image.

Note that it is possible to cause a computer to realize the color specifying section, the necessary region defining region, the removal processing section, and the combining processing section which are included in the image processing apparatus of each of the embodiments of the present invention. In this case, (i) a program for causing the computer to function as each of the color specifying section, the necessary region defining region, the removal processing section, and the combining processing section and (ii) a computer-readable recording medium in which the program is recorded are also encompassed in the scope of each of the embodiments of the present invention.

### INDUSTRIAL APPLICABILITY

An image processing apparatus of each of the present embodiments is applicable to an apparatus for processing image data for printing and suitable for a multifunction printer, a copying machine, a facsimile, a printer, and the like. Further, an image processing apparatus of each of the present embodiments is also applicable to a personal computer.

### REFERENCE SIGNS LIST

1 Control section (Color specifying section, Necessary region defining section, Combining processing section, Removal processing section)
5 ASIC
7 I/F section (Input section)
9 Display section
10 Network communication section (Input section)
22 Stamp image
22a Unnecessary region
23 Binary image
24 Binary image
25 Combined image
30 Multifunction printer (Image processing apparatus)

1. An image processing apparatus for carrying out a combining process in which a target image to be combined is superimposed over a part of an original image,
said image processing apparatus comprising:
an input section for receiving a stamp image including the target image to be combined;
a color specifying section for receiving a command to specify a color of an unnecessary region of the stamp image which region is not to be superimposed over the original image in the combining process;
a necessary region defining section for causing a display section to display a discriminating image in which a specified color region of the stamp image which region is constituted by pixels indicating the color specified by the command is discriminable, and receiving a command to define a necessary region of the specified color region which necessary region should not be defined as the unnecessary region; and
a combining processing section for whitening the part of the original image, over which part the target image to be combined is to be superimposed, and superimposing, over the part of the original image which part has been whitened, the target image to be combined, assuming that the unnecessary region is a region of the stamp image which region is obtained by excluding the necessary region from the specified color region and the target image to be combined is a region other than the unnecessary region in the stamp image.

2. The image processing apparatus as set forth in claim 1, wherein:
assuming that, in the specified color region, a region which is constituted by connected pixel groups is a connected region, the necessary region defining section carries out, with respect to the specified color region, a labeling process in which identical labels are put on pixels of an identical connected region and different labels are put on pixels which belong to different connected regions; and
the necessary region defining section allows a user to define a part of the discriminating image, and recognizes, as the necessary region, a region of the stamp image which region is constituted by pixels sharing an identical label with the part defined by the user.

3. The image processing apparatus as set forth in claim 1, further comprising:
a removal processing section for removing, from the stamp image, a contour part of the target image to be combined,
the combining processing section superimposing, over the original image, the target image which has been subjected to the removal.

4. The image processing apparatus as set forth in claim 2, further comprising:
a removal processing section for removing, from the stamp image, a contour part of the target image to be combined,
the combining processing section superimposing, over the original image, the target image which has been subjected to the removal.

5. An image processing method for carrying out a combining process in which a target image to be combined is superimposed over a part of an original image,
said image processing method comprising:
(a) receiving a stamp image including the target image to be combined;
(b) receiving a command to specify a color of an unnecessary region of the stamp image which region is not to be superimposed over the original image in the combining process;
(c) causing a display section to display a discriminating image in which a specified color region of the stamp image which region is constituted by pixels indicating the color specified by the command is discriminable, and receiving a command to define a necessary region of the specified color region which necessary region should not be defined as the unnecessary region; and
(d) whitening the part of the original image, over which part the target image to be combined is to be superimposed, and superimposing, over the part of the original image which part has been whitened, the target image to be combined, assuming that the unnecessary region is a region of the stamp image which region is obtained by excluding the necessary region from the specified color region and the target image to be combined is a region other than the unnecessary region in the stamp image.

6. A computer-readable recording medium in which a program is recorded for controlling an image processing apparatus recited in claim 1, the program causing a computer to function as the color specifying section, the necessary region defining region, and the combining processing section of the image processing apparatus.
